(19) United States
(12) Patent Application Publication
(10) Pub. No.: US 2007/0123266 A1
(43) Pub. Date: May 31, 2007

(54) Method for signalling and time reduction during connection release

(76) Inventors: Rohini Polisetty, Shaikper/Hyd. (IN); Richard C. Burbidge, Hook (GB)

Correspondence Address: MOTOROLA INC, 600 NORTH US HIGHWAY 45, ROOM AS437, LIBERTYVILLE, IL, 60048-5343, US

(21) Appl. No.: 11/287,611

(22) Filed: Nov. 28, 2005

(51) Int. Cl. H04Q 7/20

(52) U.S. Cl. 455/452.2; 455/450

(57) ABSTRACT

A method in a communication device of releasing a radio resource control (RRC) connection in a CELL_FACH or CELL_DCH state is disclosed. The method comprises the steps of receiving (202) an RRC connection release message and responding (204) to the RRC connection release message to release the RRC connection without further signaling.

### FIELD OF THE INVENTION

The present invention relates generally wireless communication systems and in particular to connection release.

### BACKGROUND OF THE INVENTION

In a wireless communication system, a call is typically setup at the beginning of a call and released at the end of a call. This allows for the management of the communication link(s) between the remote device, also known as user equipment (UE), and at least one base station. Setting up the link establishes channel and other signaling information used for the exchange of information such as in a telephone call, data exchange control information or any combination thereof. Tearing down or releasing the call frees up the communication channels that will no longer be in use so that they may be used for other communications.

In general, the UE initiates a radio resource control (RRC) connection establishment procedure that is responsible for controlling UE radio configuration during a call for example. The RRC connection is initiated when upper layers of software in the UE request the establishment of a signaling connection with the network and the UE is in idle mode (no RRC connection exists). The RRC layer in the UE leaves the idle mode and initiates an RRC connection establishment by sending an RRC Connection Request message.

In the case where a call is terminated and the UE does not receive the RRC connection release message from the base station due to inadequate signaling or other reasons, the UE waits and does not enter the idle state. This prevents the UE from making a subsequent call. Often the user of the UE will desire to immediately place another call after termination of a previous call and cannot because the UE has not been properly released. The user may attempt to place the subsequent call and the RRC establishment fails and the connection is not made. In some instances the UE will not be ready to make a new call for sixty seconds or more.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows an exemplary user equipment and network.

FIG. 2 shows an exemplary communications ladder diagram.

FIG. 3 shows an exemplary communications ladder diagram.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

While the present invention is achievable by various forms of embodiment, there is shown in the drawings and described hereinafter several examples of embodiments with the understanding that the present disclosure is to be considered an exemplification of the invention and is not intended to limit the invention to the specific embodiments contained herein as will become more fully apparent from the discussion below. It is further understood that the call release method and apparatus of the present invention may be used more generally in any application where it is desirable to provide effective RRC connection release.

Disclosed is a method in a communication device, of releasing a radio resource control channel, which is a dedicated control channel (DCCH) connection, in one embodiment, in a CELL_FACH state, i.e. a dedicated physical channel has not been allocated to the UE, or CELL_DCH state, i.e. a dedicated physical channel has been allocated to the UE. The method comprising the steps of receiving a radio resource control (RRC) connection release message at the UE. Then, responding to the RRC connection release message to release the RRC connection without further signaling. Then the device may enter the idle state after releasing the RRC connection and therefore is available to establish a subsequent communication link to make another call for example.

Before describing in detail exemplary embodiments that are in accordance with the present invention, it should be observed that the embodiments reside primarily in signaling methodology and apparatus. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It is understood that the use of relational terms, if any, such as first and second, top and bottom, and the like are used solely to distinguish one from another entity or action without necessarily requiring or implying any actual such relationship or order between such entities or actions.

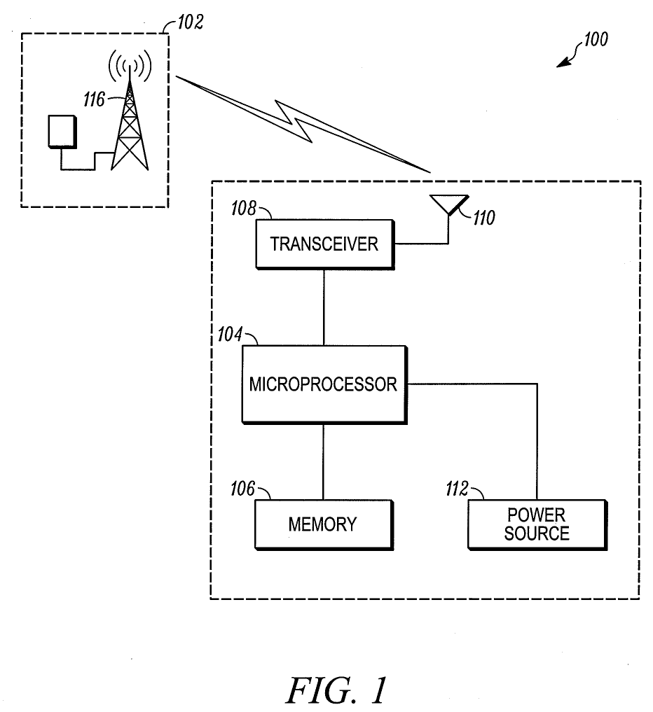

FIG. 1 is an exemplary block diagram of a wireless communication device 100 configured to operate in a communications network 102. The device 100 comprises a processor 104, memory 106, a transceiver 108, an antenna 110 and a power source 112. The network 102 comprises a base station 116, which is coupled to the Radio Network Controller (RNC) 118

In the UTRAN RRC connected mode, the UE may be in a CELL_FACH state, CELL_DCH state, a URA_PCH state or a CELL_PCH state. In this embodiment, the connection between the UE and the network may be released when the UE is in the CELL_FACH state or the CELL_DCH state.

In this exemplary embodiment, the portable device is a wireless communication device such as a radiotelephone handset. The radiotelephone described herein is a representation of the type of wireless communication device that may benefit from the present invention. However, it is to be understood that the present invention may be applied to any type of multiple housing, hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) and the like. Accordingly, any reference herein to the wireless communication device or radiotelephone 100 should also be considered to apply equally to other hand-held or portable electronic devices.

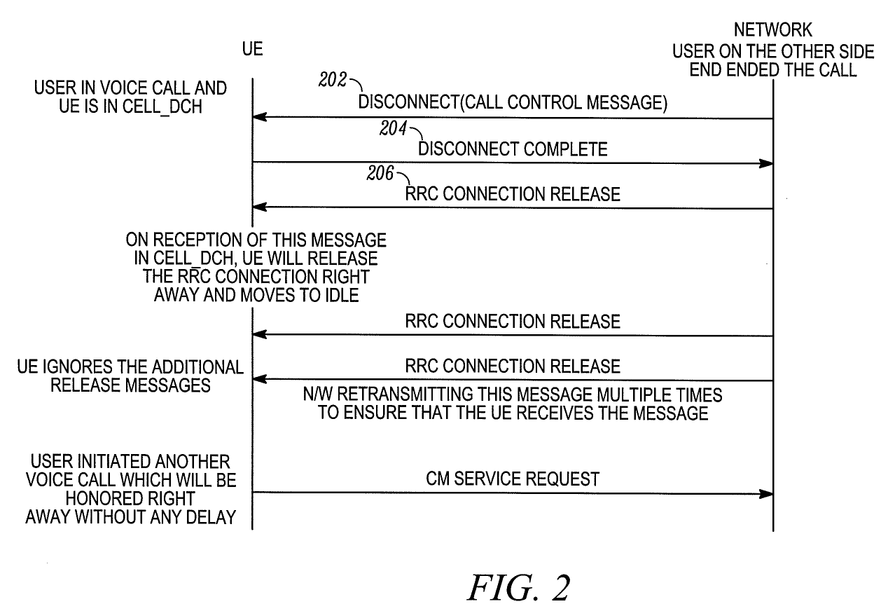

FIG. 2 is an exemplary communications ladder diagram 200 showing the user equipment on the left and the network on the right illustrating the communication flow between the UE and the network, via the base station 116, during a call release. The release of a call between the UE and the network may be initiated at either end, i.e. the UE or the network or a remote device in communication with the UE through the network.

In this exemplary embodiment, the UE 100 receives 202 a disconnect call control message from the network on the DDCH. The UE 100 sends 204 a disconnect complete message to the network. In response to the receipt of the disconnect complete message, the network sends an RRC connection release message 206 to the UE 100. Upon receipt of the RRC connection release message 206, the UE 100 responds thereto, to release the RRC connection without further signaling. In this embodiment the UE 100 enters the idle state after releasing the RRC connection. The UE 100, according to this exemplary embodiment, releases the RRC connection in no more than two seconds.

Once the UE releases the connection, the UE 100 may enter the idle state. A new call may be established once the UE is in idle mode. Since the UE is not waiting to receive the RRC connection release message from the base station 116, the UE may begin to form a new connection.

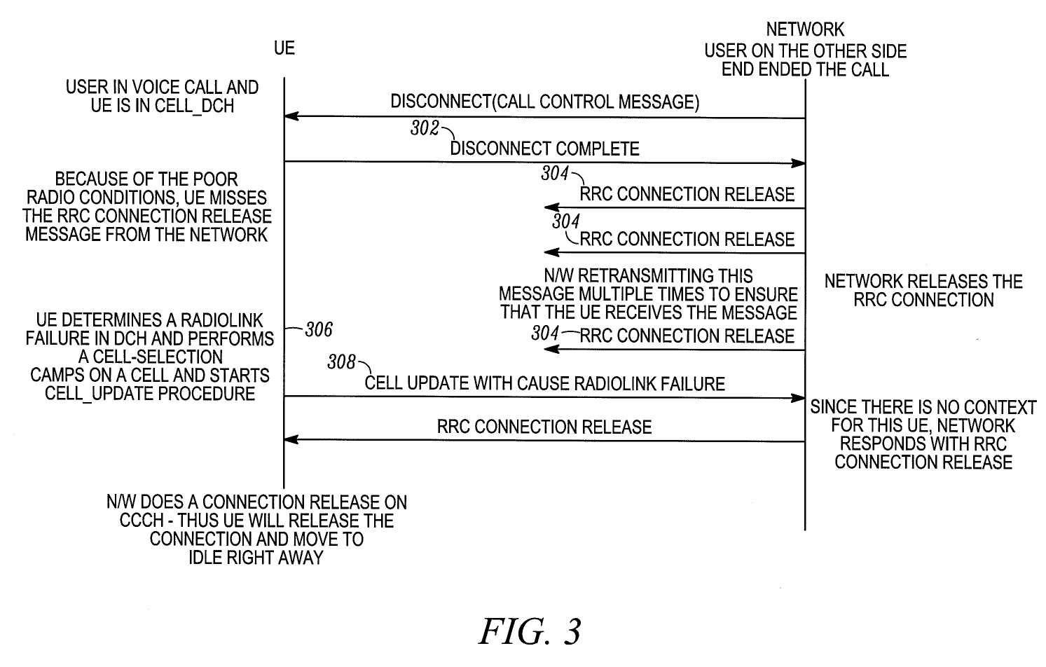

FIG. 3 shows an exemplary communications ladder diagram 300 illustrating the user equipment on the left and the network on the right showing the communication flow between the UE and the network during a cell update. In this embodiment after the disconnect complete message is sent 302 by the UE 100 to the network 102, the network 102 sends 304 RRC connection release messages to the UE 100 as discussed above. In this embodiment a plurality of RRC connection release messages are sent by the network to increase the chance that the UE 100 will receive the message. In this embodiment, however, the RRC connection release messages are not received by the UE 100. This may be the result of weak signals or adverse conditions affecting the radio frequency transmission between the network and the UE 100. Upon receiving the disconnect complete message, the network discards the context associated with the UE 100 and ceases transmission to the mobile.

The UE 100, after sending the disconnect complete and without receiving the RRC connection release message, determines a radio link failure due to the transmission to the mobile ceasing and performs 306 a cell selection, camps on the selected cell and then begins the cell update procedure by sending 308 a CELL UPDATE message to the network.

Upon receipt of the CELL UPDATE message for the context associated with the UE 100. The network resends 310 the RRC connection release message responsive to determining that the UE does not have a context. The context in this embodiment is an active state.

In yet another embodiment, the method of releasing the radio resource control channel (RRC) connection in a CELL_FACH or CELL_DCH state, comprises the steps of receiving an RRC connection release message and responding to the RRC connection release message to unconditionally release the RRC connection within a fixed predetermined interval.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. In a communication device, a method of releasing a radio resource control (RRC) channel connection in a CELL_FACH or CELL_DCH state, the method comprising the steps of:
receiving an RRC connection release message on a dedicated control channel;
responding to the RRC connection release message to release the RRC connection without further signaling.

2. The method according to claim 1, further including the step of entering the idle state after releasing the RRC connection.

3. The method according to claim 1, wherein the step of responding releases the RRC connection in no more than 2 seconds.

4. In a communication device, a method of releasing a radio resource control channel (RRC) connection in a CELL_FACH or CELL_DCH state, the method comprising the steps of:
receiving an RRC connection release message on a dedicated control channel;
releasing the RRC connection upon receipt of the RRC connection release message without further signaling.

5. The method according to claim 4, further including the step of entering the idle state after releasing the RRC connection.

6. The method according to claim 4, wherein the step of releasing automatically releases the RRC connection in less than 2 seconds.

7. The method according to claim 4, wherein the communication device releases the RRC connection without further signaling of an RRC connection release complete message.

8. In a communication device, a method of releasing a radio resource control channel (RRC) connection in a CELL_FACH or CELL_DCH state, the method comprising the steps of:
receiving an RRC connection release message;
responding to the RRC connection release message to unconditionally release the RRC connection within a fixed predetermined interval.
